(19) United States
(12) Patent Application Publication
(10) Pub. No.: US 2014/0043114 A1
(43) Pub. Date: Feb. 13, 2014

(54) MICROWAVE TM MODE RESONATOR AND AN ELECTRICAL FILTER INCLUDING SUCH A RESONATOR

(71) Applicant: Filtronic Wireless Limited, Yeadon (GB)

(72) Inventor: Christopher Ian Mobbs, West Yorkshire (GB)

(73) Assignee: Filtronic Wireless Limited, Yeadon (GB)

(21) Appl. No.: 13/960,590

(22) Filed: Aug. 6, 2013

(30) Foreign Application Priority Data
Aug. 7, 2012 (GB) 1214130.5

(51) Int. Cl. H01P 7/10

(52) U.S. Cl. CPC H01P 7/105; H01P 1/2002; H01P 7/06
USPC 333/219.1; 333/235

(57) ABSTRACT

A microwave TM mode resonator includes a resonator cavity defined by an electrically conducting cavity wall having first and second spaced apart end faces and a side wall extending therebetween. The resonator further includes a resonator body within the cavity extending along its length between the first and second end faces, wherein a portion of the length of the resonator body is a dielectric and a further portion of the length is a metal.

The present invention relates to a microwave TM mode resonator and an electrical filter including such a resonator. More particularly, but not exclusively, the present invention relates to a microwave TM mode resonator comprising a resonator body within a cavity defined by an electrically conducting cavity wall, a portion of the length of the resonator body being a dielectric and another portion of the length being a metal. More particularly, but not exclusively, the present invention also relates to an electrical filter including such a microwave TM mode resonator.

Microwave TM mode resonators are often included in electrical filters. However, such known microwave TM mode resonators having a high Q tend to be large. Often the resonator is the largest component of the filter and so determines the minimum dimensions of the filter, in particular the filter thickness. Reducing the size of the resonator typically reduces its Q factor which is undesirable.

The present invention seeks to overcome the problems of the prior art.

Accordingly, in a first aspect, the present invention provides a microwave TM mode resonator comprising
a resonator cavity defined by an electrically conducting cavity wall, the cavity wall comprising first and second spaced apart end faces and a side wall extending therebetween; and,
a resonator body within the resonator cavity extending along its length between the first and second end faces;
a portion of the length of the resonator body being a dielectric and a further portion of the length being a metal.

Provision of a resonator body which comprises both dielectric and metal portions enables the resonator to be shrunk in size with minimal reduction in Q value.

Preferably, the resonator body comprises a dielectric portion sandwiched between metal portions.

Preferably, the dielectric is a ceramic.

At least one of the first and second end faces can be spring loaded, the spring urging the end face into contact with the resonator body.

Preferably, the microwave TM mode resonator according to the invention further comprises a tuning screw.

Preferably, the tuning screw extends through one of the end faces into a dielectric portion of the resonator body.

Preferably, the tuning screw extends through a metal portion of the resonator body into the dielectric portion.

Preferably, the tuning screw extends through the dielectric portion of the resonator body into a further metal portion of the resonator body

The tuning screw can be a dielectric tuning screw.

The tuning screw can be an electrically conducting tuning screw, preferably a metal.

The microwave TM mode resonator according to the invention can further comprise an insulating layer, preferably PTFE, between the tuning screw and further metal portion of the resonator body.

Preferably, the tuning screw is received in a recess in the end face.

An end face of a metal portion of the resonator body can form part of an end face of the resonator cavity.

In a further aspect of the invention there is provided an electrical filter comprising at least one TM mode resonator as claimed in any of claims 1 to 10.

The present invention will now be described by way of example only and not in any limitative sense with reference to the accompanying drawings in which

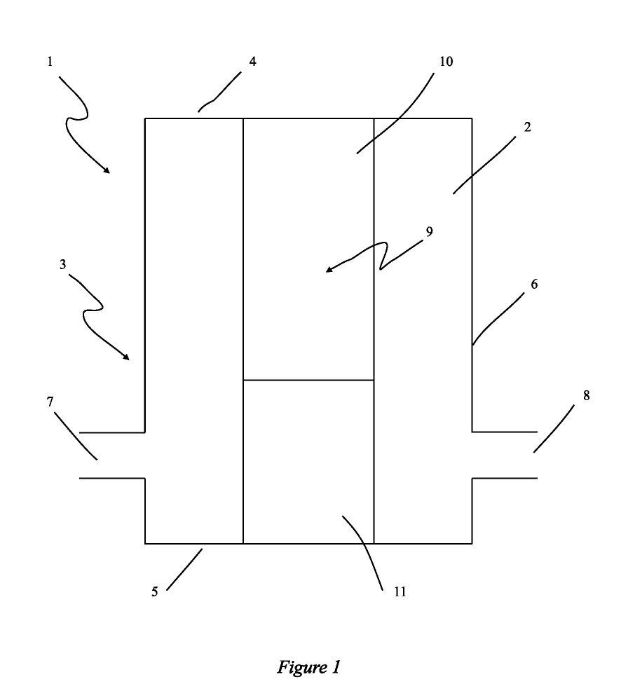

FIG. 1 shows a first embodiment of a microwave TM mode resonator according to the invention.

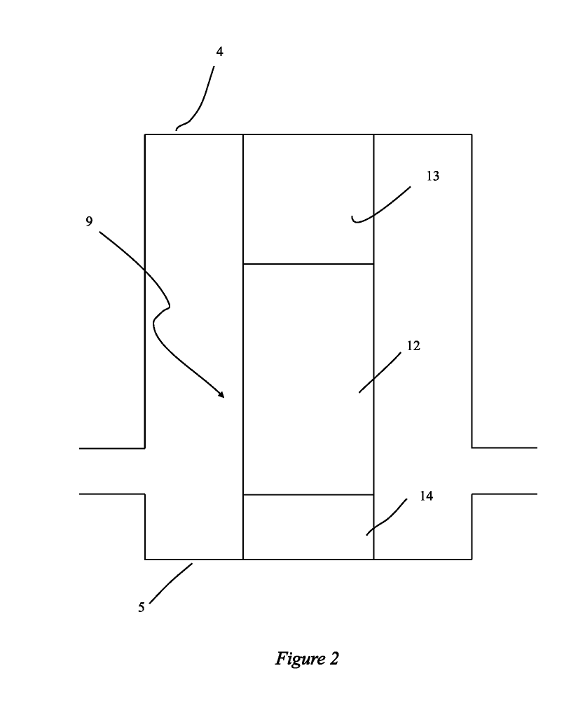

FIG. 2 shows a further embodiment of a microwave TM mode resonator according to the invention;

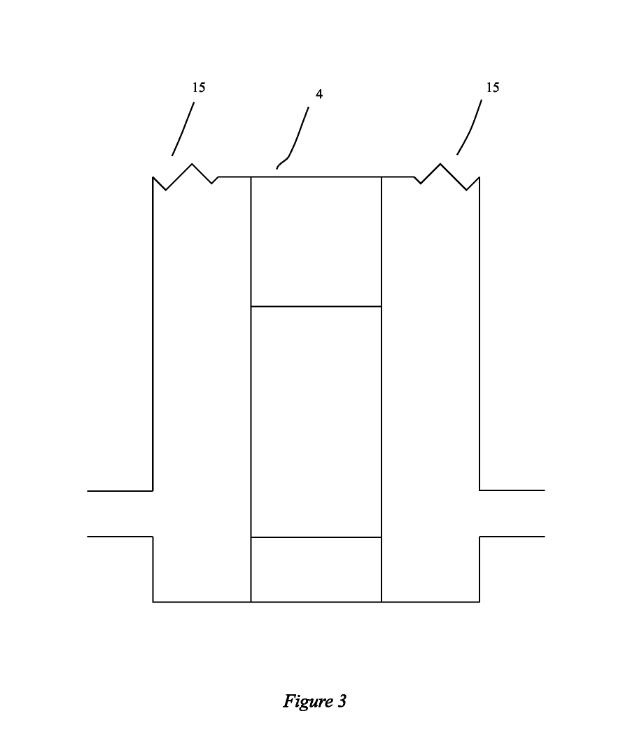

FIG. 3 shows a further embodiment of a microwave TM mode resonator according to the invention;

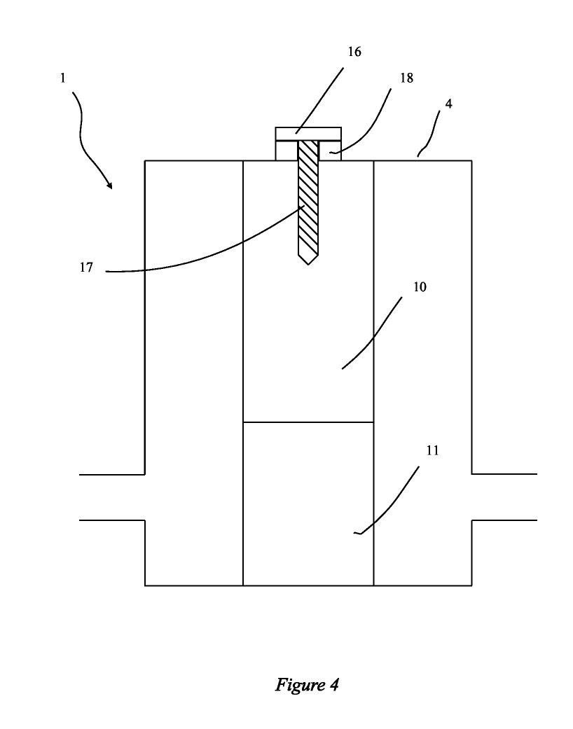

FIG. 4 shows a further embodiment of a microwave TM mode resonator according to the invention;

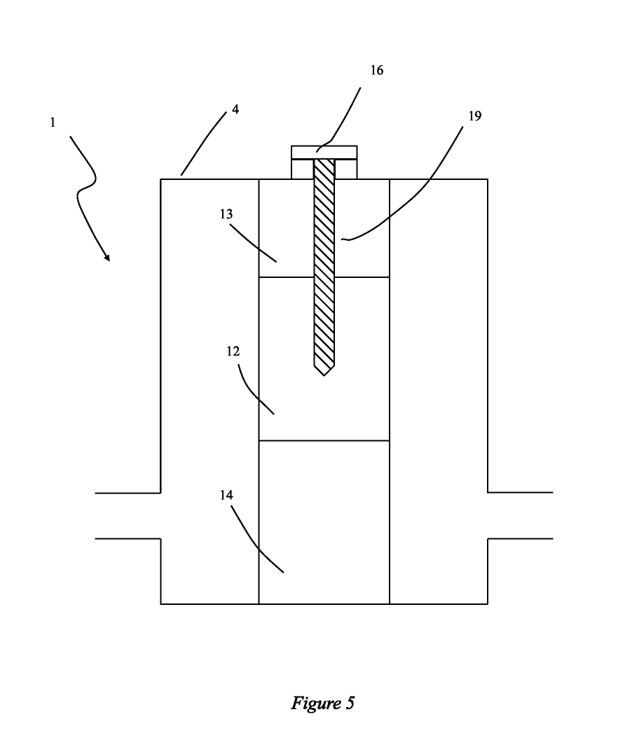

FIG. 5 shows a further embodiment of a microwave TM mode resonator according to the invention; and,

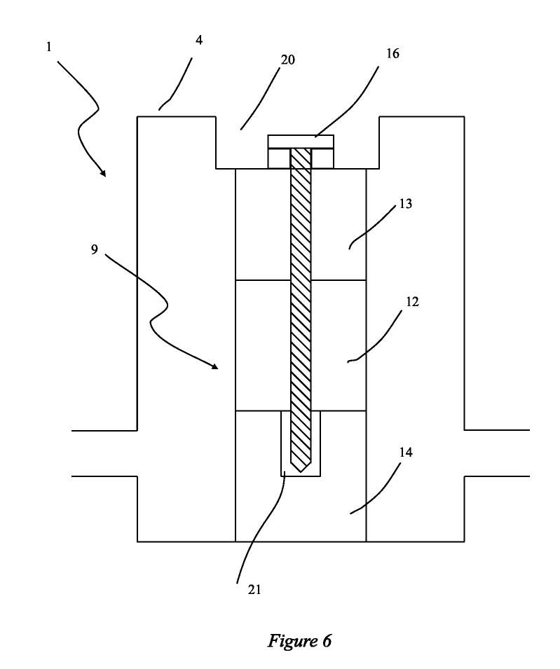

FIG. 6 shows a further embodiment of a microwave TM mode resonator according to the invention.

Shown in FIG. 1 is a first embodiment of a microwave TM mode resonator 1 according to the invention. The resonator 1 comprises a resonator cavity 2 defined by an electrically conducting cavity wall 3. The cavity wall 3 comprises first and second end faces 4,5 and a side wall 6 extending therebetween. Input and output ports 7,8 extend through the side wall 6 for entry and exit of the microwave signal as shown.

Arranged within the resonator cavity 2 is a resonator body 9 used to determine the resonant frequency of the resonator 1 as is known to one skilled in the art. The resonator body 9 extends along its length from the first end face 4 to the second end face 5 as shown. A first portion 10 of the length of the resonator body 9 comprises a dielectric, in this case a ceramic. A second portion 11 of the length of the resonator body 9 comprises a metal.

The microwave TM mode resonator 1 according to the invention is smaller than most known microwave TM mode resonators for an equivalent Q value. In addition, because a portion 11 of the resonator body 9 is a metal, rather than a more typical and expensive ceramic, it is also less expensive to manufacture.

Shown in FIG. 2 is an alternative embodiment of a microwave TM mode resonator 1 according to the invention. This embodiment is similar to that of FIG. 1 except the resonator body 9 is divided into three portions—a first ceramic portion 12 is sandwiched between first and second metal portions 13,14. Each of the metal portions 13,14 abuts an adjacent end face 4,5 as shown. In FIG. 2 the ceramic and metal portions 12,13,14 are each of an equal size. In alternative embodiments the two metal potions 13,14 are of an equal size but are of a different size to the ceramic portion 12. In a further alternative embodiment the two metal portions 13,14 are different sizes to each other.

In the embodiments described above the resonator body 9 is typically slightly larger than the gap between the first and second faces 4,5. This ensures a good fit between the resonator body 9 and the end faces 4,5 with the end faces 4,5 urging the resonator body 9 into compression. A good fit between the resonator body 9 and the end faces 4,5 produces a significant improvement in the performance of the resonator 1.

Shown in FIG. 3 is a further embodiment of the microwave TM mode resonator 1 according to the invention. This is similar to FIG. 2 except one of the end faces 4 is spring loaded. In this embodiment the spring 15 is an integral part of the end face 4 arranged around the circumference of the end face 4 as shown. The spring 15 urges the end face 4 downwards urging it into contact with the resonator body 9. The resonator 1 can accommodate resonator bodies 9 of slightly different lengths. The spring will extend or contract to accommodate the resonator body 9.

Shown in FIG. 4 is a further embodiment of a microwave TM mode resonator 1 according to the invention. The resonator 1 is similar to that of FIG. 1 except it further comprises an electrically conducting tuning screw 16. The end face 4 comprises an aperture 17. Fixed to the end face 4 and covering the aperture 17 is a threaded nut 18. The tuning screw 16 is threaded through the nut 18 and extends into the ceramic portion 10 of the resonator body 9. The tuning screw 16 is in electrical contact with the nut 18 which in turn is in electrical contact with the end face 4. By turning the screw 16 its position can be altered relative to the ceramic and metal portions 10,11 of the resonator body 9, so altering the resonant frequency of the resonator 1.

Shown in FIG. 5 is a further embodiment of a microwave TM mode resonator 1 according to the invention. In this embodiment the tuning screw 16 extends through an aperture 19 in a metal portion 13 of the resonator body 9 and into the ceramic portion 12. The metal portion 13 typically comprises a thread on the inner face of the aperture 19 with which the screw 16 engages. Again, by turning the screw 16 the resonant frequency of the resonator 1 can be altered.

Shown in FIG. 6 is a further embodiment of a microwave TM mode resonator 1 according to the invention. In this embodiment the end face 4 comprises a recess 20 as shown. Arranged in the recess 20 is the tuning screw 16. By arranging the screw 16 within the recess 20 the overall size of the resonator 1 can be reduced. In this embodiment the tuning screw 16 extends through a first metal portion 13 of the resonator body 9, through a ceramic portion 12 of the resonator body 9 and then into a further metal portion 14 of the resonator body 9 as shown. An insulating layer 21 (in this case PTFE) is arranged between the tip of the tuning screw 16 and the second metal portion 14 of the resonator 1 as shown to prevent electrical contact between the metal portion 14 and the tip of the tuning screw 16.

In an alternative embodiment (not shown) the top metal portion 13 of the resonator body 9 includes a recess into which the tuning screw 16 is received. In this embodiment the end face of the metal portion 13 forms part of the end face 4 of the resonator cavity 2.

The resonator 1 is typically employed in a microwave electrical filter. The microwave signal passes into the resonator 1 via the input port 7, through the resonator 1 and then exits the resonator via the exit port 8. The resonator 1 can be employed in many different types of electrical filter, for example bandstop or bandpass filters. The filter may employ more than one resonator 1 according to the invention. The resonators 1 could be connected in parallel or in series.

A number of possible ceramic materials can be employed in the resonator 1 as would be appreciated by one skilled in the art. A typical ceramic material comprises E43 from NTK Technologies.

The portion of the length of the resonator body 9 made of ceramic material is typically in the range 5% to 80%, more preferably in the range 25% to 50%.

As to dimensions of the resonator 1, the resonator 1 is typically cylindrical with a cylindrical resonator body 9 arranged on the axis of symmetry of the resonator cavity 2. At 700 MHz a typical resonator would have a cavity dimension of 30 mm high with a 50 mm diameter. The ceramic portion of the resonator body 9 is typically 16 mm in diameter and 13 mm high. The metal portions of the resonator body 9 on each side of the ceramic portion are typically of the order 18 mm in diameter and 8.5 mm high.

In all of the above embodiments the tuning screw is an electrically conducting tuning screw. In alternative embodiments of the invention the tuning screw is a dielectric tuning screw.

1. A microwave TM mode resonator comprising:
a resonator cavity defined by an electrically conducting cavity wall, the cavity wall comprising first and second spaced apart end faces and a side wall extending therebetween;
a resonator body within the resonator cavity extending along its length between the first and second end faces; and
a portion of the length of the resonator body being a dielectric and a further portion of the length being a metal.

2. A microwave TM mode resonator as claimed in claim 1, wherein the resonator body comprises a dielectric portion sandwiched between metal portions.

3. A microwave TM mode resonator as claimed in claim 2, wherein the dielectric is a ceramic.

4. A microwave TM mode resonator as claimed in claim 1, wherein at least one of the first and second end faces is spring loaded, the spring urging the end face into contact with the resonator body.

5. A microwave TM mode resonator as claimed in any claim 1, further comprising a tuning screw.

6. A microwave TM mode resonator as claimed in claim 5, wherein the tuning screw extends through one of the end faces into the dielectric portion of the resonator body.

7. A microwave TM mode resonator as claimed in claim 6, wherein the tuning screw extends through the metal portion of the resonator body into the dielectric portion.

8. A microwave TM mode resonator as claimed in claim 7, wherein the tuning screw extends through the dielectric portion of the resonator body into a further metal portion of the resonator body.

9. A microwave TM mode resonator as claimed in claim 8, wherein the tuning screw is a dielectric tuning screw.

10. A microwave TM mode resonator as claimed in claim 8, wherein the tuning screw is an electrically conducting tuning screw.

11. A microwave TM mode resonator as claimed in claim 10, further comprising an insulating layer between the tuning screw and further metal portion of the resonator body.

12. A microwave TM mode resonator as claimed in claim 5, wherein the tuning screw is received in a recess in the end face.

13. A microwave TM mode resonator as claimed in any claim 1, wherein an end face of a metal portion of the resonator body forms part of an end face of the resonator cavity.

14. An electrical filter comprising at least one TM mode resonator as claimed in claim 1.

15.-16. (canceled)

17. A microwave TM mode resonator as claimed in claim 1, wherein the dielectric is a ceramic.

18. A microwave TM mode resonator as claimed in claim 10, wherein the electrically conducting tuning screw is a metal.
